(19) United States
(12) Patent Application Publication
(10) Pub. No.: US 2014/0266857 A1
(43) Pub. Date: Sep. 18, 2014

(54) Fusing Radar and Communications Data in a Bi-Static Passive RF Link

(71) Applicant: Physical Sciences, Inc., Andover, MA (US)

(72) Inventors: Peter Mayer, Andover, MA (US); James T. Demers, Methuen, MA (US)

(21) Appl. No.: 13/797,037

(22) Filed: Mar. 12, 2013

(51) Int. Cl. G01S 13/00

(52) U.S. Cl. CPC G01S 13/003
USPC 342/60

(57) ABSTRACT

The invention provides, in one aspect, a method for communicating data with a radar signal. The method includes transmitting a radar signal from a first location, the radar signal including data encoded therein. The radar signal is reflected off of a target object (or multiple target objects) at a second location. The method further includes receiving the reflected radar signal at a third location, and decoding the data encoded in the received radar signal.

### TECHNICAL FIELD

This invention relates to fusing communications data with radar waveforms, using orthogonal frequency division multiplexing (OFDM) or other techniques to optimize the use of the bandwidth for communicating digital data, and has been applied to a bi-static communications scenario where a radar signal reflects off an airborne target to a receiver.

### BACKGROUND

Advances in digital communications techniques, improved methods for using RF spectrum, and advanced signal processing techniques have enabled gains in bit-error rates (BER), bandwidth utilization, and signal-to-noise ratios (SNR). However, there has been little advancement in fusing the realms of communications and radar signal processing; and no progress addressing bi-static communications situations.

Current communications techniques among deployed naval assets rely on Link-16 satellite links, Link-16 RF line-of-sight between ships (or forwarded via E-2C/other aircraft), and the so-called cooperative engagement capability (CEC). However, all of the links, particularly the satellite link, suffer from bandwidth saturation in scenarios involving many tracked targets/objects, especially as the number of communicants increases. In addition, the CEC is only possible using dedicated RF transmit (Tx)/receive (Rx) elements present on a subset of Navy ships, does not service ballistic missile defense, and only works via line of sight. Link-16 line-of-sight is similarly limited to tens of kilometers between the Tx and Rx, unless air superiority is assumed and an aircraft can forward the information. There are several situations where two assets desire to communicate although they are somehow prevented; they may not have line-of-sight because they are over the horizon with respect to each other, there is hostile interference, or existing communications channels are saturated and therefore unavailable.

### SUMMARY

One advantage of the invention is that a receiver can compensate for range delay and Doppler shifts to a transmitted signal, and can both decode the transmitted information and implement matched filtering on the portions of waveforms which are known in advance. Another advantage is that dual use of radar bandwidth for both detection and communication can enable better use of spectrum in scenarios where existing communication links may be saturated, e.g., through over-use or denied through hostile methods. Another advantage of the invention is that it can also use forward error correction (FEC) for improving BER, and can mitigate multipath interference. Another advantage of the invention is it can enable the use of bi-static radar over long baselines (distances between Tx and Rx), which in turn can enable substantial (up to a factor of 100) reduction in tracked object position and velocity uncertainties, with corresponding benefits in terms of reduced radar resources, track accuracy, and/or related system functions. A targeted area for the technology can be, for example, Aegis ballistic missile defense.

In one aspect, the invention provides a method of communicating by bouncing a radar signal off of a (passive) target object, and receiving the information stored in the signal at a different radar site. In some embodiments, this can be a collection of hostile objects that reflect radar, or a single friendly object, such as a spherical balloon or an unmanned air vehicle (UAV.)

In another aspect, the invention provides a method for encoding, transmitting, receiving, and decoding (processing) signals when they are built from orthogonal frequency division multiplexed (OFDM) subcarriers, including the limiting case of a single BPSK channel, but extending to other modulation schemes (e.g. quadrature phase shift keyed (QPSK)).

In another aspect, the invention provides a method for choosing an object from which to extract the communication signal when the passive target object is part of a group of objects, such as using a 2D CFAR on a range-Doppler image, with a choice for the best object to use based on the maximal post pulse compressed signal-to-noise ratio (SNR) of each object. In some embodiments, the group of objects is a hostile threat group (e.g., a missile complex), and the chosen object is a booster or other large scatterer within the group.

In another aspect, the invention provides a method of sending timing and state information needed for bistatic ranging using the above methods, allowing for bistatic range estimation with minimal additional communication demands on other channels.

In another aspect, the invention provides a method for sending tracking and resource scheduling information through the channel, allowing for persistent tracking of threats using multiple radars, and fusing the data of the radar tracks from geographically distinct sites, including the monostatic tracks.

In another aspect, the invention provides a method for communicating data with a radar signal. The method includes transmitting a radar signal from a first location, the radar signal including data encoded therein. The radar signal is reflected off of a target object (or multiple target objects) at a second location. The method further includes receiving the reflected radar signal at a third location, and decoding the data encoded in the received radar signal.

In some embodiments, the method involves decomposing the data into a bit-stream and passing the bit-stream through a turbo-code algorithm for adding forward error correction (FEC) to the data prior to encoding. In related embodiments, the method involves encoding the data into the radar signal by shifting a phase of each bit by either 0 degrees or 180 degrees using e^{iπb}, where b is an associated bit value. In further related embodiments, the method involves placing the encoded data bits across OFDM subcarriers, evenly spaced by nΔf as the frequency for subcarrier band n, and having m bits of information in each subcarrier. In some embodiments, the method involves performing an inverse Fourier transform across each band of the OFDM subcarriers.

In some embodiments, the method involves transmitting the encoded data at a particular azimuth and a particular elevation such that the radar signal is reflected off of the target object.

In some embodiments, the method involves (i) modulating the received signal back down from a carrier frequency to a baseband frequency, (ii) digitizing the modulated signal using an ADC, and (iii) bringing the signal frequency back to a frequency domain by performing a Fourier transform on the digitized, modulated signal.

In some embodiments, the method involves compensating for signal changes during transmission between any of the first location, second location, and third location. In related embodiments, the method involves using range and Doppler information for the target object to compensate for the signal changes. In other embodiments, the target object comprises any of (i) one or more hostile objects, (ii) one or more friendly objects, (iii) a spherical balloon, or (iv) an unmanned aerial vehicle (UAV).

In another aspect, the invention provides a system for communicating data with a radar signal. The system includes a transmitter, including at least a data processor, that transmits a radar signal from a first location, the radar signal including data encoded therein. A receiver, including at least a data processor, that receives the radar signal at a second location after it was reflected off of one or more target objects at a third location. The receiver decodes data encoded in the received signal.

In some embodiments, the transmitter decomposes the data into a bit-stream and passes the bit-stream through a turbo-code algorithm for adding forward error correction (FEC) to the data prior to encoding. In related embodiments, the transmitter encodes the data into the radar signal by shifting a phase of each bit by either 0 degrees or 180 degrees using e^{iπb}, where b is an associated bit value. In further related embodiments, the transmitter places the encoded data bits across OFDM subcarriers, evenly spaced by nΔf as the frequency for subcarrier band n, and having m bits of information in each subcarrier. In still further related embodiments, the transmitter performs an inverse Fourier transform across each band of the OFDM subcarriers.

In some embodiments, the transmitter transmits the encoded data at a particular azimuth and a particular elevation such that the radar signal is reflected off of the one or more target objects.

In some embodiments, the receiver (i) modulates the received signal back down from a carrier frequency to a baseband frequency, (ii) digitizes the modulated signal using an ADC, and (iii) brings the signal frequency back to a frequency domain by performing a Fourier transform on the digitized, modulated signal.

In some embodiments, the receiver compensates for signal changes during transmission between any of the first location, second location, and third location. In related embodiments, the receiver uses range and Doppler information for the one or more target objects to compensate for the signal changes.

In other embodiments, the one or more target objects comprise any of (i) one or more hostile objects, (ii) one or more friendly objects, (iii) one or more spherical balloons, or (iv) one or more unmanned aerial vehicles (UAV).

### BRIEF DESCRIPTION OF THE DRAWINGS

A more complete understanding of the invention can be attained by reference to the drawings, in which:

FIG. 1 depicts a bi-static scenario using a fused radar and communications technique to aid tracking of a ballistic missile complex according to one implementation of the invention;

FIG. 2 depicts transmitter and receiver flow for a fused radar and communications system according to one implementation of the invention.

FIG. 3 depicts a bit-error rate, with and without forward error correction (FEC), as a noise floor increases according to one implementation of the invention; and

FIG. 4 depicts BPSK encoding according to one implementation of the invention.

### DETAILED DESCRIPTION

The problem of communicating between two moving platforms not within RF line-of-sight, and when existing communications channels are saturated by other traffic or being denied, can be solved by using encoded digital communications data as a radar waveform. With an appropriate design for the transmitter and receiver, this can yield both radar imagery/tracking data as well as the transferred communications data. The communicated data can be general enough to send any information, but in one proposed instance of the technology, its particular use can be transmitting state information from one radar to another. For example, the method can be used to send track information from a forward-based Aegis radar to a rear-based Aegis radar hundreds of kilometers away without use of satellite links by bouncing a communication waveform off of a large target object (e.g., booster stage.) In the event that satellite communications are overwhelmed, denied, or suffer from prohibitive latencies, this can enable successful ballistic missile defense.

In another instance of the technology, the information transfer can enable “bistatic radar,” a type of RF tracking which can require two spatially separate participants, a transmitter (Tx) and a receiver (Rx). Bistatic tracking can enable substantial performance enhancements over monostatic (where Rx is the same as Tx) radar systems. Bistatic radar can be “enabled” in the sense that tracking using the bistatic radar requires information to be continually sent from the Tx to the Rx. To see the most benefit from the bistatic tracking, the distance between the Tx and Rx can often be much longer than the RF line-of-sight distance. Currently, no good methods exist for sending this information and coordinating the Tx and Rx, particularly with low latency. The proposed innovation can enable this information transfer at the same time as performing the tracking function.

In another instance of the technology, forward error-correction (FEC) can be applied to the transmitted information signal, improving the bit-error rate (BER) at the receiver.

In another instance of the technology, the received known portion of the sent waveform can be passed through a matched filter and subsequent processing to enable clock recovery and range/Doppler estimation of the target. This information can then be used to aid the communication receiver in recovering the unknown portion of the sent waveform by reducing the required frequency and phase search space.

A simulation was developed encompassing some of the algorithm(s) described herein in the context of single-target tracking and communications. Additional capabilities include methods and systems for combining multiple signals from multiple objects for better SNR, both for tracking and communication using a rake-like receiver; allocating space for data and header information in a single waveform to adjust the waveform for optimal tracking (low RMSE in position and velocity) and communication (high bandwidth, low BER) based on available SNR from the target; and reconstituting a tactical communication network when aerial active repeater platforms (e.g., aircraft, satellite links, etc.) are not available or are saturated.

### Bi-Static Solution

FIG. 1 depicts an exemplary bi-static scenario 100 using a fused radar and communications technique to aid tracking of a ballistic missile complex according to one implementation of the invention. More specifically, FIG. 1 shows a transmitter 120 (e.g., aboard a ship or otherwise) sending digital data 125 (e.g., encoded radar tracking information) embedded in a communication waveform that is reflected off of one or more target objects 130 (e.g., ballistic missile, booster stage, hostile object, friendly object, etc.). The reflected signal 135 is received and decoded by a receiver 140 (e.g., aboard a ship or otherwise).

A bi-static method that allows communications over existing radar bandwidth can provide a communications channel while preserving radar detection and tracking capabilities. The use of bistatic tracking or bistatic information transfer has the potential to greatly enhance the function of missile defense, if the barriers to communicating some or all of the useful information (Tx timing, Tx ship position and beam direction, resource planning information, local track info, etc.) to the Rx can be lowered. Few bi-static radar systems attempt to operate over-the-horizon, and none attempt to communicate in this manner. Additionally, bi-static radar systems become more important, for example, as more transmitting ships are used, and a multi-static scenario could easily be used with each transmitter sending information to multiple receivers.

Certain known technical concepts can be incorporated into the present technology including:
1) Wireless communications systems adopting the IEEE 802.11g/n standards also use OFDM for improving bandwidth utilization of the 2.4 GHz spectrum. These also have the ability to compensate for multi-path interference up to a point.
2) BPSK is currently used in satellite communications.
3) The method proposed by Sturm functions for automotive detections and communications, but crucially, does not enable or employ bistatic radar (it is monostatic), nor does it employ a radar reflection off of a “target” object between the Rx and Tx, with all of the related benefits and applications.

Certain known methods may be included in the subject technology, but these methods have been used for completely different purposes or in fundamentally different ways. They can include:
1) The wireless OFDM systems are used purely for communications, and provide no radar capabilities. They also have no ability to integrate multi-path returns for increasing the SNR.
2) BPSK—a well-established communication waveform.
3) Although Sturm, et al, have attempted a similar data fusion technique in automotive communications and automation systems, they have the advantage of performing this only in a mono-static scenario. This provides the distinct advantage of knowing a priori the transmitted signal, allowing for optimal radar signal reconstruction because all time and phase delays may be easily computed.

FIG. 2 depicts transmitter and receiver algorithmic flow for a fused radar and communications system according to one implementation of the invention. The fused radar and communications algorithm can comprise two main parts. The first can process and transmit the communications data as a radar waveform. The second can receive the waveform and process it to recover the transmitted data while also obtaining a radar return.

### Transmitter

The transmitter (e.g., transmitter 120) can perform several steps. First, as shown in step 200, the digital data can be decomposed into a bit-stream of zeroes and ones. This bit-stream can be passed through a turbo-code algorithm for adding forward error correction (FEC) to the stream, as shown in step 205. The resultant bit-stream, although larger, mathematically provides a theoretically optimal ability to reconstruct the transmitted data and improve the bit-error rate (BER) at the receiver. This can also prevent the need for a back-channel communications mechanism for requesting a retransmission of the data.

FIG. 3 depicts a bit-error rate (BER) percentage 310 versus noise floor 320, with forward error correction (FEC) 330 and without FEC 340. More specifically, it depicts a graph showing the improvement to BER when FEC is used, as a function of increasing background noise. At some point, the noise can overwhelm the signal entirely and the data is irrecoverable.

Returning to FIG. 2, the next step 210 can encode the bit-stream into a signal with one of two phases for each bit depending on its value. This can be easily performed by shifting the phase by either 0 or 180 degrees, using e^{iπb}, where b is the bit value. Although this binary phase-shift keying (BPSK) of the digital stream makes inefficient use of bandwidth, its simplicity and robustness easily compensate for this; most satellite communications systems can use BPSK because of this robustness.

FIG. 4 shows the BPSK encoding method according to one implementation of the invention. More specifically, the left side depicts a constellation mapping of digital input bits onto an I/Q phase plot 410. On the right side, is the phase-encoded bit stream 420 as it appears over time in one sub-carrier.

FIG. 4, more particularly, includes an in-phase axis 411 of the constellation plot; a quadrature axis 412 of the constellation phase plot, shifted 90 degrees in phase from the in-phase axis 411; a digital representation of a zero bit 413 in the constellation plot; a digital representation of a one bit 414 in the constellation plot; a time axis (abscissa) 421; an amplitude of transmitted signal (ordinate) 422; a transmitted signal 423 representing the bits (e.g., 0, 1, 0) being transmitted; an amount of time 424 taken to transmit one: bit; and a label 425 for the time axis 421.

Returning to FIG. 2, the transmitter can then place the data bits across all the OFDM subcarriers, as shown in step 215, evenly spaced in frequency by nΔf as the frequency for subcarrier band n, and having m bits of information in each subcarrier. The number of subcarrier bands can directly correspond to the number of range gates; the number of bits, or “chips,” per band corresponds to the number of Doppler bins. Next, an inverse Fourier transform can be performed across each of the subcarrier bands, as shown in step 220. The results for all the subcarriers can be summed together, modulated up to a carrier frequency, f_{c}, as shown in step 225, and then transmitted at a particular azimuth and elevation such that it will reflect off an airborne target (e.g., one or more target objects 130). The effects of background thermal noise 230 and non-coherent broadband jamming 235 on the SNR have been simulated during testing of this method. FIG. 2 depicts the processing flow of the simulation for both transmission and reception according to one implementation of the invention.

### Receiver

The receiver (e.g., receiver 140) can perform more processing than the transmitter. The receiver can take the reflected signal, modulate it back down from the carrier frequency to baseband, digitize it using an ADC, and perform a Fourier transform to bring the signal back to the frequency domain. This can reconstruct the subcarriers as well, separating them into their respective frequency bands. Processing can continue in two disparate yet dependent tasks, one for radar 250 and one for communications 260. The current concept of operations (CONOPS) for this system can alternate between radar and communications processing for each received signal.

For radar processing 250, the received signal can compensate for signal changes during its transit, e.g., as shown in step 251. A Doppler shift can occur between the transmitter and the airborne target, and again between the target and the receiver. Each subcarrier band can have a linearphase shift across each chip, equal to e^{2πif}^{_{Du}}, with f_{D} being the Doppler shift and u the chip number within the band. The range offset can cause a linear phase shift over the bands for each chip position, according to

$${e}^{\frac{2 π in Δ fR}{c}} ,$$

with n being the band number, Δf the bandwidth for each band, R the total range traveled by the signal, and c the speed of light.

Once adjusted for Doppler and range effects, the signal can have a Hann window applied over the chips and then over the bands. This can reduce the sidelobe levels as we perform a Fourier transform over the chips, and an inverse Fourier transform over the bands. This can result in a range-Doppler map, as shown in step 252, which may then be sent to a 2D stencil CFAR detector, as shown in step 253, returning the range and Doppler frequency of the target of interest, as shown in step 254. The detected target can then be sent to a tracker (e.g., Kalman-based or otherwise) that predicts the location at the next discrete time step, as shown in step 255. This location can be used by the communications processing task, described next.

The communications processing task 260 can use the range and Doppler information for the target to compensate for the received signal, as shown in steps 261, 262. Once that has been done, the BPSK receiver can convert the chips in each subcarrier band back to a bit stream, as shown in step 263. The FEC can then be decoded, as shown in step 264, resulting in the original bit-stream of the communicated data, as shown in step 265.

The communicated data results in the receiver obtaining both the bistatic radar tracking information (bistatic range, bistatic Doppler) and the communication information encoded by the transmitter (e.g. information pertaining to transmitter timing, position, beam pointing, track information, etc.). This can allow for bistatic tracking in one instance. This can allow for track forwarding in another instance. In general, it can allow for information transfer simultaneous with radar tracking

### System Hardware and Software

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the technology by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit). Subroutines can refer to portions of the computer program and/or the processor/special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for longterm data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage devices suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The computing system can include clients and servers. A client and a server are generally remote from each other and typically interact through a communication network. The relationship of client and server arises by virtue of computer programs running on the respective computers and having a client-server relationship to each other.

The components of the computing system can be interconnected by any form or medium of digital or analog data communication (e.g., a communication network). Examples of communication networks include circuit-based and packet-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Devices of the computing system and/or computing devices can include, for example, a computer, a computer with a browser device, a telephone, an IP phone, a mobile device (e.g., cellular phone, personal digital assistant (PDA) device, laptop computer, electronic mail device), a server, a rack with one or more processing cards, special purpose circuitry, and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). A mobile computing device includes, for example, a Blackberry®. IP phones include, for example, a Cisco® Unified IP Phone 7985G available from Cisco System, Inc, and/or a Cisco® Unified Wireless Phone 7920 available from Cisco System, Inc.

One skilled in the art will realize the technology can be embodied in other specific forms without departing from the spirit or essential characteristics thereof. The foregoing embodiments are therefore to be considered in all respects illustrative rather than limiting of the technology described herein. Scope of the technology is thus indicated by the appended claims, rather than by the foregoing description, and all changes that come within the meaning and range of equivalency of the claims are therefore intended to be embraced therein.

It will be appreciated that the illustrated embodiment and those otherwise discussed herein are merely examples of the technology and that other embodiments, incorporating changes thereto, fall within the scope of the technology.

In view of the forgoing, what I claim is:

1. A method of communicating data with a radar signal comprising:
A) transmitting a radar signal from a first location, the radar signal including data encoded therein;
B) reflecting the radar signal off a target object at a second location;
C) receiving the reflected radar signal at a third location; and
D) decoding the data encoded in the received radar signal.

2. The method of claim 1, further comprising decomposing the data into a bit-stream and passing the bit-stream through a turbo-code algorithm for adding forward error correction (FEC) to the data prior to encoding.

3. The method of claim 2, further comprising encoding the data into the radar signal by shifting a phase of each bit by either 0 degrees or 180 degrees using e^{iπb}, where b is an associated bit value.

4. The method of claim 3, further comprising placing the encoded data bits across OFDM subcarriers, evenly spaced by nΔf as the frequency for subcarrier band n, and having m bits of information in each subcarrier.

5. The method of claim 4, further comprising performing an inverse Fourier transform across each band of the OFDM subcarriers.

6. The method of claim 1, further comprising transmitting the encoded data at a particular azimuth and a particular elevation such that the radar signal is reflected off of the target object.

7. The method of claim 1, further comprising (i) modulating the received signal back down from a carrier frequency to a baseband frequency, (ii) digitizing the modulated signal using an ADC, and (iii) bringing the signal frequency back to a frequency domain by performing a Fourier transform on the digitized, modulated signal.

8. The method of claim 1, further comprising compensating for signal changes during transmission between any of the first location, second location, and third location.

9. The method of claim 8, further comprising using range and Doppler information for the target object to compensate for the signal changes.

10. The method of claim 1, wherein the target object comprises any of (i) one or more hostile objects, (ii) one or more friendly objects, (iii) a spherical balloon, or (iv) an unmanned aerial vehicle (UAV).

11. A system for communicating data with a radar signal, comprising:
a transmitter, including at least a data processor, that transmits a radar signal from a first location, the radar signal including data encoded therein;
a receiver, including at least a data processor, that receives the radar signal at a second location after it was reflected off of one or more target objects at a third location; and
wherein the receiver decodes data encoded in the received signal.

12. The system of claim 11, wherein the transmitter decomposes the data into a bit-stream and passes the bit-stream through a turbo-code algorithm for adding forward error correction (FEC) to the data prior to encoding.

13. The system of claim 12, wherein the transmitter encodes the data into the radar signal by shifting a phase of each bit by either 0 degrees or 180 degrees using e^{iπb}, where b is an associated bit value.

14. The system of claim 13, wherein the transmitter places the encoded data bits across OFDM subcarriers, evenly spaced by nΔf as the frequency for subcarrier band n, and having m bits of information in each subcarrier.

15. The system of claim 14, wherein the transmitter performs an inverse Fourier transform across each band of the OFDM subcarriers.

16. The system of claim 11, wherein the transmitter transmits the encoded data at a particular azimuth and a particular elevation such that the radar signal is reflected off of the one or more target objects.

17. The system of claim 11, wherein the receiver (i) modulates the received signal back down from a carrier frequency to a baseband frequency, (ii) digitizes the modulated signal using an ADC, and (iii) brings the signal frequency back to a frequency domain by performing a Fourier transform on the digitized, modulated signal.

18. The system of claim 11, wherein the receiver compensates for signal changes during transmission between any of the first location, second location, and third location.

19. The system of claim 18, wherein the receiver uses range and Doppler information for the one or more target objects to compensate for the signal changes.

20. The system of claim 11, wherein the one or more target objects comprise any of (i) one or more hostile objects, (ii) one or more friendly objects, (iii) one or more spherical balloons, or (iv) one or more unmanned aerial vehicles (UAV).
